(19) United States
(12) Patent Application Publication
(10) Pub. No.: US 2016/0188150 A1
(43) Pub. Date: Jun. 30, 2016

(54) INTUITIVE GRAPHICAL USER INTERFACE FOR A CLOUD-BASED NATURAL LANGUAGE UNDERSTANDING ENGINE

(71) Applicant: VOICE ENABLING SYSTEMS TECHNOLOGY INC., Waterloo (CA)

(72) Inventors: Kacem Abida, Waterloo (CA); Sergiu Giurgiu, Kitchener (CA); Kevin Halk, Ayr (CA); Fakhreddine Karray, Waterloo (CA)

(21) Appl. No.: 14/792,108

(22) Filed: Jul. 6, 2015

Related U.S. Application Data
(60) Provisional application No. 62/020,780, filed on Jul. 3, 2014.

(51) Int. Cl. G06F 3/0486; G06F 17/27; G06F 3/0482; G10L 15/22; G06F 3/16; G10L 15/32; G10L 13/00

(52) U.S. Cl. CPC G06F 3/0486; G10L 15/32; G06F 17/2705; G10L 13/00; G06F 17/279; G10L 15/22; G06F 3/167; G06F 3/0482

(57) ABSTRACT

A graphical user interface of a web-based toolkit application for a cloud-based NLU engine is a drag-and-drop toolkit application for building NLU contextual recognition models. Using the graphical user interface, users who do not have expertise in NLU and text interpretation can focus on building customized NLU contextual recognition models to enable human (end-user) interaction with electronics and software applications without requiring expert programming skills or prior in-depth knowledge of NLU. The NLU models provide an intelligent, natural conversational speech and/or text interface for end-users of electronic devices and software applications.

### BACKGROUND

The present application relates to speech technology, specifically the area of Natural Language Understanding (herein after “NLU”) and text interpretation. Currently, the design and implementation of an NLU engine is reserved for the highly-trained and specialized. Thus, the cost and time for implementing an NLU engine in a device (such as a simple consumer device) is prohibitively high.

### SUMMARY

A graphical user interface of a web-based toolkit application for a cloud-based NLU engine is a drag-and-drop toolkit application for building NLU contextual recognition models. Using the graphical user interface, users who do not have expertise in NLU and text interpretation can focus on building customized NLU contextual recognition models to enable human (end-user) interaction with electronics and software applications (herein after the “associated client applications”) without requiring expert programming skills or prior in-depth knowledge of NLU. The NLU models provide an intelligent, natural conversational speech and/or text interface for end-users of electronic devices and software applications.

The toolkit's graphical user interface features a series of interactive development, live-testing, and deployment windows including a sandbox for building a hierarchical framework, a set of configuration menus, and a set of development, live testing, and deployment command buttons. Through this intuitive graphical user interface, a user who is a novice in the areas of NLU and text interpretation, can easily configure the three main components of an NLU engine, namely the Parser, the Dialog Manager, and the Prompt Generator, without knowing what they are, what each does or the interactions among these components, to yield a working, customized NLU model. The functions of the three main components are as follows:

The Parser spots and collects data in the form of keyword values identified by the user for each transaction and passes them to the Dialog Manager.

The Dialog Manager analyses the data collected by the Parser by checking it against the NLU model definition. The user can define conditions through the toolkit's user interface such that Dialog Manager and the Prompt Generator can determine the appropriate static or context-sensitive response message to the end-user of the associated client application. The Dialog Manager transfers the prompt messages and the end-user choices that comply with the NLU model definition to the associated client application for processing and storage.

The Prompt Generator receives data from the Dialog Manager and uses it to generate the system response message containing static and context-sensitive content for the end-user of the associated client application. Upon generating the prompt messages, the Prompt Generator returns the prompt messages to the user of the client application.

The present invention is in the field of Natural Language Understanding (NLU) speech technology. The invention is the graphical user interface of a web-based drag-and drop toolkit application for building NLU contextual recognition models; these NLU models provide an intelligent, natural conversational speech and/or text interface for end-users of electronic devices and software applications.

The toolkit's graphical user interface is a series of interactive windows featuring a drag-and-drop sandbox for constructing the framework of the NLU model, a set of configuration menus, and a set of command buttons for development, live testing, and deployment functions. The design of the toolkit's graphical user interface integrates the underlying NLU engine such that a novice user without a background in NLU and text interpretation, can easily and quickly build NLU contextual recognition models that are customized for the associated application. The NLU Engine's main components are the Parser, the Dialog Manager, and the Prompt Generator.

In order to use the toolkit's graphical user interface to build a customized NLU contextual recognition model, the user is only required to determine what end-user transactions in the associated client application need to be interpreted, either as menu navigation or form data capture transactions, plus the governing conditions, including the keyword values that activate each transaction. Unlike many other NLU engines, keyword values are used rather than training data. With this information in hand, the user is ready to use the web-based toolkit's user interface.

The user then uses drag-and-drop actions in the graphical user interface's sandbox to model these transactions as a hierarchical framework of nodes; each path through the framework defines a transaction choice available to the associated client application's end-user. Upon defining each node, the user uses click or click-and-add actions in a set of menus provided in the graphical user interface to configure conditions and keyword values. When modeling is complete, the user can live test and deploy the NLU model to the cloud repository by clicking buttons provided in a toolbar. An API enables two-way communication between the deployed NLU model and the associated client application.

These and other features of the invention would be better understood from the following specifications and drawings, the following of which is a brief description.

### BRIEF DESCRIPTION OF THE DRAWINGS

The drawings that accompany the detailed description can be briefly described as follows:

FIG. 1 is a schematic view of an ecosystem supported through the NLU engine toolkit's graphical user interface.

FIG. 1A is a schematic of one possible hardware arrangement for implementing the NLU engine toolkit of FIG. 1.

FIG. 2 is a schematic view of the three main components of the NLU engine underlying its toolkit's graphical user interface and the query-response processing relationships between the components.

FIG. 3 is an example graphical user interface for NLU model project initiation and administration functions.

FIG. 4 is an example graphical user interface for NLU model creation and editing functions including the launching of live test and deployment functions.

FIG. 5 is an example graphical model interface of the live testing window.

### DETAILED DESCRIPTION

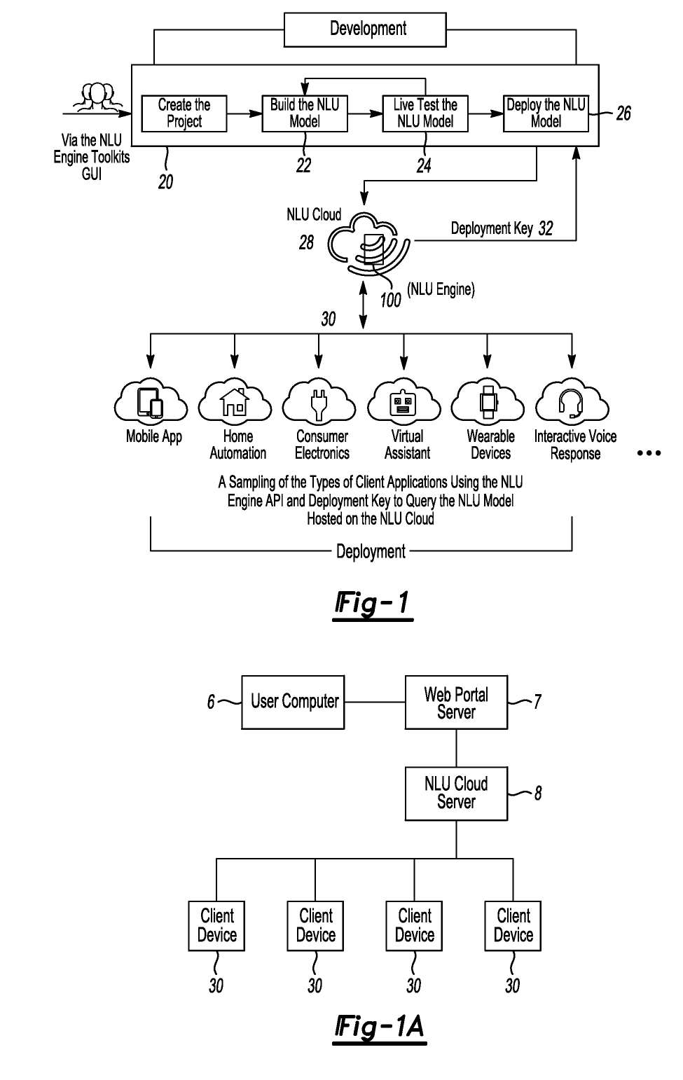

FIG. 1 illustrates a project created by a user to contain an NLU model 20. The user builds the NLU model 20 at step 22, live-tests the NLU model 20 at step 24, and deploys the NLU model 20 at step 26. Upon deployment, an NLU engine 100 residing in the NLU cloud 28 returns a deployment key 32 to the user. By implementing the deployment key 32 into an associated application programming interface (herein after “API”) calling from a cloud-client application 30 to an NLU server (not shown), the user can enable a two-way communication with the associated NLU model 20. The cloud-client application 30 is, in one example, both an electronics product and a software application. The cloud-client application 30 has a variety of platforms including mobile applications, home appliance control, consumer electronics, virtual assistants, etc.

FIG. 1A is a schematic of one possible hardware arrangement for implementing the NLU engine toolkit of FIG. 1. The user accesses a computer 6, such as a personal computer, tablet, or other computing device having a processor, memory and network hardware for accessing a web portal server 7, such as over the Internet. The web portal server 7 is a computer (having a processor, memory and network hardware) providing the GUI described herein and providing access to the NLU cloud server 8. The NLU cloud server 8 is a computer (having a processor, memory and network hardware) providing access (such as over the Internet) to the client devices 30.

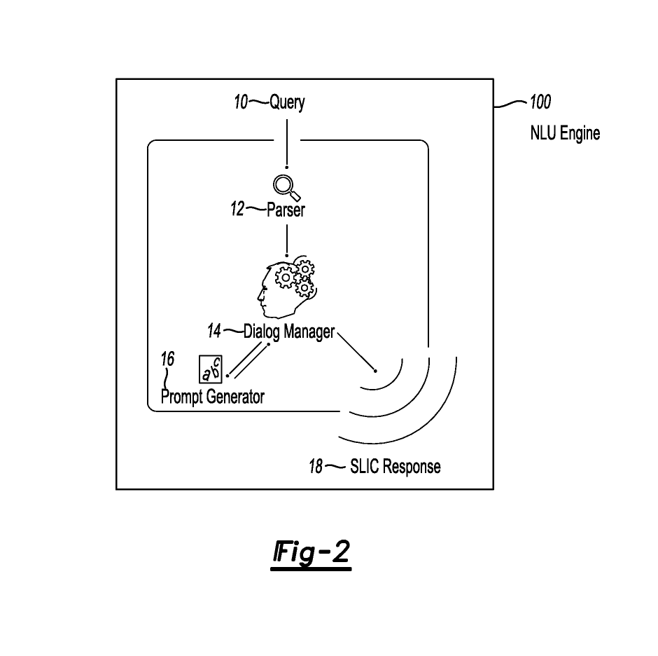

FIG. 2 illustrates a query-processing path through the NLU engine's 100 main components: a query 10, a parser 12, a dialog manager 14, and a prompt generator 16. The query 10, parser 12, dialog manager 14, and prompt generator 16 are all in communication with each other. In one example, the query 10 is in the form of a voice input through a connected microphone and an automatic speech recognizer. In another example, the query 10 is in the form of a text input using a text inputting device. In one example, the text inputting device can be a keyboard, key pad, or a touch screen. The parser 12 spots and collects a keyword value data selected by the cloud-client application's 30 end user and passes the keyword value data to the dialog manager 30. The dialog manager 14 analyzes the keyword value data by checking it against the NLU model 20 definition for the appropriate transaction type and transfer compliant end-user (i.e. keyword values) to the associated cloud-client application 30 for processing and storage. The prompt generator 16 receives the keyword value data from the dialog manager 14 and uses it to generate an NLU system message response. In one example, the NLU system message response contains static content 54. In another example, the NLU system message response contains context-sensitive content. The prompt generator 16 then returns the NLU system messages to the user of the cloud-client application 30. The user can define conditions of the NLU model by an example graphical user interface display 49 such that the dialog manager 14 and the prompt generator 16 can determine an appropriate NLU system message response to the user of the cloud-client application 30.

If the NLU model 20 definition includes prompt messages, the dialog manager 14 communicates with the prompt generator 16 and provides the prompt generator 16 with data to build the NLU system message. The prompt generator 16 returns an appropriate prompt message to the dialog manager 14. The dialog manager 14 returns the appropriate prompt message to the user in an NLU engine response 18. In one example, the NLU engine response 18 is a voice utterance through a text-to-speech engine. In another example, the NLU engine response 18 is a text response in a text display. The appropriate prompts guide the user of the cloud-client application 30 towards providing data required by the cloud-client application 30. The appropriate prompts also instruct courtesy messages, such as greeting messages. In one example, the appropriate prompts can be configured for the NLU model 20 for general transactions. In another example, the appropriate prompts can be configured for the NLU model 20 for selected transactions.

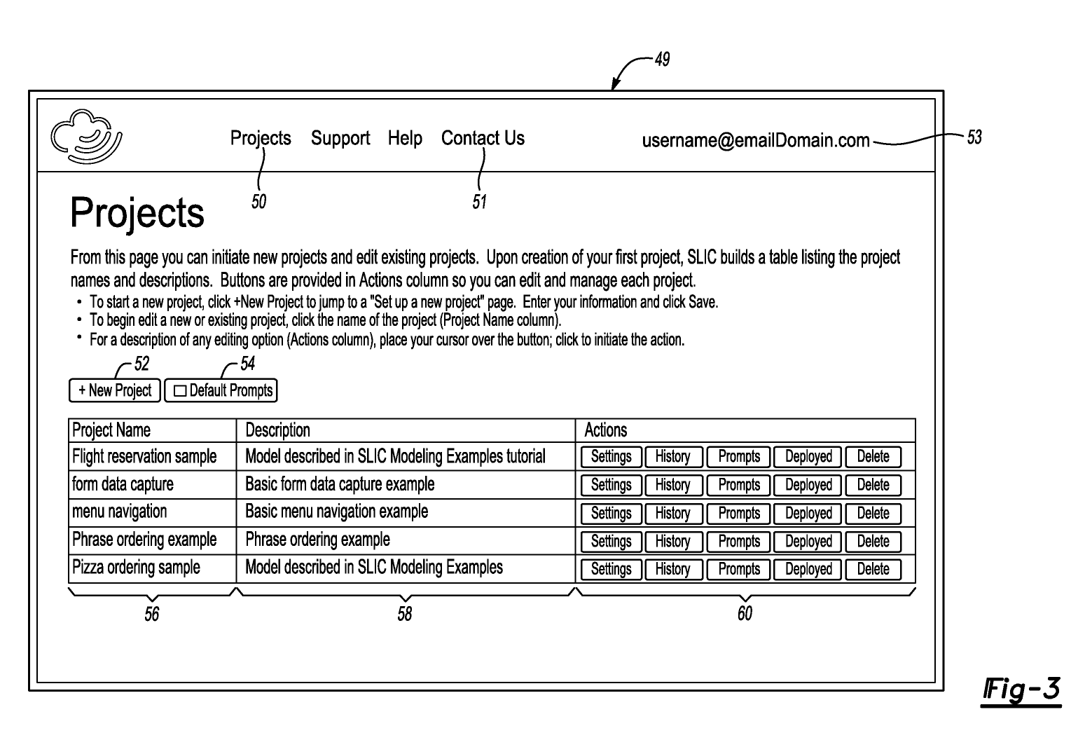

FIG. 3 is the example graphical user interface 49 display. In this example, the graphical user interface display 49 displays a projects page 50. The user may navigate to the projects page 50 by selecting a projects button 50. The projects button 50 is located in a navigation menu 51 in a web portal 53. On the graphical user interface display 49, a user may initiate a new project by selecting a new project button 52. The user can then define prompts to apply to the user's projects by selecting a default prompts button 54. The user can edit an NLU model 20 by selecting the entry of the NLU model 20 in a project name column 56. The user may also enter in a description 58 for the NLU model 20 adjacent to the project name column 56. The user may also perform administrative actions 60 on the graphical user interface display 49. The administrative actions 60 can modify settings, history, prompts, deployed, and deleting an NLU model 20. By selecting settings, the user may modify basic user information. By selecting the history, the user may modify listings of time-stamped saved and user saved versions of the NLU model 20. By selecting prompts, the user may modify universal and select transactions. When selecting the deployed action, the user may change the listing of previously deployed NLU models 20. Lastly, when selecting the delete action, the user may delete an NLU model 20.

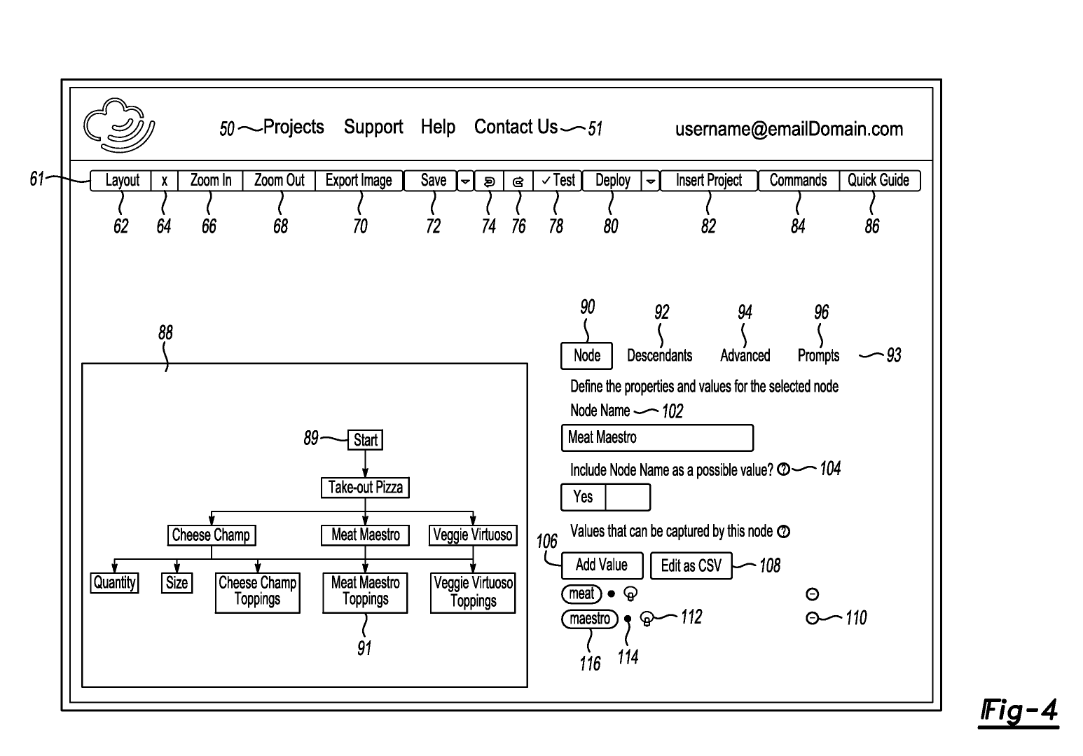

FIG. 4 is an example graphical user interface for NLU model 20 creation and editing functions. The graphical user interface display 49 has a sandbox 88. The sandbox 88 contains a single node 89 upon creation of an NLU model 20. In one example, the single node 89 is a “start” button. At any time during the building of the NLU model 20, the user can navigate to the project page 50. A toolbar 61 located under the navigation menu 51 includes the selection buttons. In one example, the selection buttons include:

A layout selection button 62, wherein the layout button refreshes and re-arranges a graph of nodes 91 located in the sandbox 88.

A center selection button 64, wherein the center selection button re-centers the graph of nodes 91.

A zoom in selection button 66 and a zoom out selection button 68, wherein the zoom in button 66 increases the zoom level for viewing the graph of nodes 91 and the zoom out button 68 decreases the zoom level for viewing the graph of nodes 91.

An export image selection button 70, wherein the export image selection button 70 exports the graph of nodes 91 as a separate file.

A save selection button 72, wherein the save selection button saves the current NLU model 20.

An undo selection button 74, wherein the undo selection button 74 un-does the last action performed.

A redo selection button 76, wherein the undo selection button 76 re-does the last action performed.

A test selection button 78, wherein the test selection button 78 live-tests the NLU model 20.

A deploy selection button 80, wherein the deploy selection button 80 deploys the NLU model 20 to the NLU cloud 28.

An insert project selection button 82, wherein the insert project selection button 82 inserts the graph of nodes 91 from one NLU model 20 into a current NLU model 20.

A commands selection button 84, wherein the commands selection button 84 displays an edit commands configuration window (not shown). The edit commands configuration window allows the user to control actions which can be configured by the cloud-client application's user. In one example, the user may want to enable a universal command allowing the user to discard previous selections chosen and start anew from the beginning of a client application. The user would use the edit commands configuration window to enable a restart command. In the same example, the user may also add words to trigger a restart command.

A quick guide selection button 86, wherein the quick guide selection button 86 displays a user help information. In one example, the quick guide selection button 86 displays user help information directly on the graphical user interface display 49.

A set of configuration menus 93 is placed adjacent the sandbox 88, as shown in FIG. 4. In one example, the set of configuration menus include a node menu 90, a descendants menu 92, an advanced menu 94, and a prompts menu 96. Each menu displays properties that are relevant to a selected node in the sandbox 88.

Node menu 90 contains configurable properties of a node N selected in the sandbox 88.

Node Menu 90 Configuration Properties

| Property | Description |
|---|---|
| Node Name 102 | Specifies the name of the selected node |
| Include the Node | Specifies whether to treat the node name as a node |
| Name as a | value |
| possible | |
| value 104 | |
| Values that can | Specify the keyword values attached to the selected |
| be captured by | node: |
| this node 106 | [symbol] button 106 to add a keyword value. |
| | [symbol] button 108 to add a file containing a list |
| | of comma-separated values. |
| | [symbol] entities showing a defined value in |
| | a capsule shape 106, a clickable green dot 114 that |
| | toggles to a yellow star which indicates that this |
| | value is a default value, a clickable light bulb icon |
| | 112 that display a list of synonyms for a defined |
| | value, and a clickable round red shape with a white |
| | horizontal bar 110 to delete an indicated value. |

Descendants menu 92 containing the configurable properties of the descendants of the node N selected in the sandbox 88.

Descendants Menu's Configuration Properties

| Property | Description |
|---|---|
| Descendant | Displays a mode for node N's descendant nodes |
| Node Mode | listed in the menu's descendant node properties |
| | section |
| Descendant | Specifies a number range of node N's descendants |
| Node Quantity | that the user must select. |
| Descendant | If enabled for node N's descendant node D, then the |
| Node Status | descendant node D must be specified by the user as |
| | part of the selection path in order to complete the |
| | transaction. |
| Selection | Specifies whether the cloud-client application should |
| Clarification | ask explicitly for the user's preferred selection before |
| | shifting from the current selected node to another |
| | node in the graph of nodes 91. |
| Phrase Ordering | Specifies a selection order of descendant node D's |
| | node name or value. |

Advanced menu 94 containing advanced configuration options for the node N selected in the sandbox 88.

Advanced Menu's Configuration Properties

| Property | Description |
|---|---|
| Overwrite | Controls an ability of the client application's user to |
| | overwrite a previous selection value with a different |
| | value. |
| Confirm | Controls whether the NLU system asks the end-user |
| | to confirm the selections made for node N. |
| Allow Swapping | Controls an option to swap one value selection for a |
| Values | different value selection. |
| Number of | Specifies a number of values that the user selects for |
| Occurrences | node N, expressed as a minimum and maximum |
| | number of values |
| Allow Removing | Controls an option to swap one value selection for a |
| Values | different value selection. |
| Enable grouping | Enable or disable an option whereby descendants |
| | and values of that node can be selected separately |
| | with no relationship between them. |

In the prompts menu 96, the user can specify the NLU system message content of either a static or context-sensitive prompt for the node N selected in the sandbox 88.

A user must perform preparatory tasks before building an NLU model 20 in the graphical user interface display 49. The preparatory tasks determine information requirements, structuring, and presentation. In one example, the information requirements, structuring, and presentation include menu navigation, logical node structures, conditions, and selection values. In the same example, the preparatory tasks include:

Reviewing the client application to decide what transactions need to be interpreted by the NLU engine 20.

Analyzing the transactions to identify and classify information needed from the client application's user.

Identifying the various options, the selection values for each option, and the conditions to be placed on each option for each “information chunk” from the identification and classification task.

Decide, if any, which NLU response messages the users will receive to facilitate the completion of the transactions (prompts to inform the users if they have made incorrect or incomplete selections, to confirm end-user selection actions or selection choices, courtesy messages, etc.)

Once the user completes the preparatory tasks, the user may then create the NLU model 20 within the graphical user interface 49. The user being with the start node 89, and creates a graph of nodes 91. In one example, each node in the graph of nodes 91 represents a menu navigation node. In another example, each node in the graph of nodes 91 represents a form data capture function node corresponding to the cloud-client applications requirements. In one example, the menu navigation nodes indicate the status of the user decisions. In another example, the form data capture nodes serve as information storage. In the same example, menu navigation nodes specify a unique path to accomplish a transaction. In still the same example, the form data capture nodes provide an optional path selection for the user. In one example, the menu nodes are represented by an ellipse shape. In the same example, the form data capture nodes are represented by an oval shape.

The user then builds the NLU model at step 22 directly in the sandbox 88. The user begins with the start node 89. A mode of the start node 89 can be specified upon project initiation by the user. The mode of any node can be changed at any time in the node menu 90. To add one or more descendant nodes from the descendant menu 92 to the start node 89 and related connectors, the user selects the start node 89 and clicks a plus button downstream of the start node 89.

All other descendant nodes are created in this manner to represent the client application's transactions. The user can connect any two nodes A and B to represent a relationship by clicking and dragging one of the four ports in node A to node B. To delete an unwanted node, the user selects it and clicks the − (minus) button on its upper edge. To delete a connector between two nodes to remove an unwanted relationship, select the unwanted connector and click Delete.

The NLU model application assigns defaults for various properties which can be over-ridden using the four configuration menus (FIG. 4: 90, 92, 94, 96) provided. Once the NLU model is completed, the user can live-test the model by clicking the test button 78. If there is insufficient and/or conflicting information is specified or if NLU model structure requirements are not met, then the NLU server returns an error message with a brief explanation describing the problem.

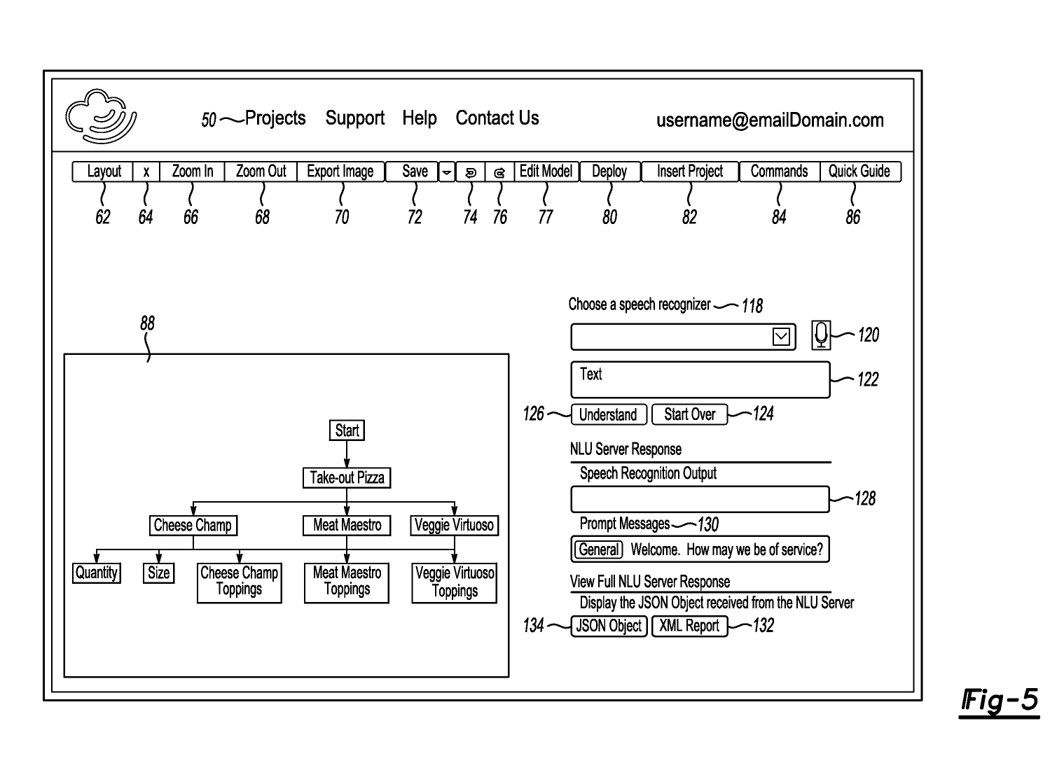

FIG. 5 is an example graphical user interface showing the live-testing view. Its toolbar replaces the test button 78 shown in FIG. 4 with a edit model button 77. When clicked, the edit model button 77 returns the user to the NLU model editing view shown as FIG. 4.

The user live-tests the NLU model with the NLU Engine in the cloud using test phrases, either through voice (requires a connected microphone) or text input. A list box 118 contains a selection of speech recognizers. A clickable microphone icon 120 is provided to indicate the start and end of the test phrase spoken into the microphone connected to the computer. The user can type the test phrase into a text entry box 112.

Once the spoken or typed test phrase is entered, the user clicks the Understand button 126 to ask the NLU engine to interpret and process the test phrase. The GUI provides a Start Over button 124 for users who choose to close the current test session and then initiate a new test session rather than continue testing phrases in the current session.

The example GUI in FIG. 5's two NLU Engine Response sections provides automatic display in the Speech Recognition Output 128 display box of the ASR recognition of the test phrase input. The Prompt Messages 130 display box containing all prompt message responses associated with the test phrase input is also automatically displayed. JSON Object button 134 can be selected to display the entire Content component of the NLU server response (returned as a JSON object). An XML Report button 132 can be selected to display the xmlReport component of the NLU server response.

The NLU Engine Response (also as 18 in FIG. 2) may be routed through a Text-To-Speech engine as a speech utterance.

The graph of nodes in the sandbox 88 displays one of three possible responses:
Success: Activated nodes in the selection path are displayed in green. The recognized keywords are displayed by each node.
Partial understanding (specified conditions are not satisfied): Activated nodes in the selection path are displayed in yellow. The recognized keywords are displayed by each node.
Failure, no part of the input phrase was understood: No color change in the node graph.

When the user is satisfied with the responses (e.g. all of the nodes are successfully tested), the user can implement the NLU model in the user's application.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A Natural Language Understanding (NLU) contextual recognition model development system comprising:
a computer configured to provide a web-based toolkit application for a user to build customized NLU contextual recognition models in a graphical user interface, the web-based toolkit application further configured to provide live-testing of the NLU model with an NLU engine in an NLU cloud using test phrases through voice recognition or text input, the web-based toolkit application further configured to deploy the NLU model to the NLU cloud.

2. The system of claim 1 wherein the building, testing, and deploying processes are all implementable by the user via a GUI.

3. The system of claim 1 wherein upon deployment, the NLU engine residing in the NLU cloud is configured to return a deployment key to the user.

4. The system of claim 1, wherein the NLU engine is configured to interpret and process the spoken or typed test phrase during live-testing.

5. The system of claim 1, wherein the graphical user interface includes a plurality of interactive windows having:
(a) a drag-and-drop sandbox for constructing the framework of the NLU model;
(b) a set of configuration menus; and
(c) a set of command buttons to permit the user to build the NLU contextual recognition models, a set of command buttons to permit the user to initiate the live-testing, and a set of command buttons to permit the user to deploy the NLU model to the NLU cloud.

6. The system of claim 5, wherein the GUI provides a selection of speech recognizers.

7. The system of claim 5, wherein the GUI displays an automatic display in a Speech Recognition output display.

8. The system of claim 5, wherein the GUI displays an automatic display in a Prompt Messages display.

9. The system of claim 5, wherein the GUI permits the user to display an entire content component of an NLU server response.

10. The system of claim 5, wherein the GUI is configured to permit the user to display an Extensive Markup Language (XML) report component of the NLU server response.

11. A Natural Language Understanding (NLU) contextual recognition model development system comprising:
a computer configured to provide a query input and a parser that spots and collects query data in the form of keyword values, the computer configured to provide a dialog manager that analyzes the data collected by the parser by checking it against the NLU model definition, the computer configured to provide a prompt generator that receives input from the dialog manager and creates system response messages containing static or context-sensitive content and returns the generated content to the dialog manager for transmission to the end-user, the dialog manager configured to then transmit the context in an NLU engine response.

12. The system of claim 11, wherein the NLU engine response can be returned as a speech utterance through a text-to-speech engine or as a text response in a text display.

13. The system of claim 11, wherein the query is a voice input.

14. The system of claim 13, wherein the voice input is received through a connected microphone and an automatic speech recognizer.

15. The system of claim 11, wherein the query is a text input.

16. The system of claim 11, wherein the NLU engine response is returned as a speech utterance through a text-to-speech engine.

17. The system of claim 11, wherein the NLU engine response is returned as a text response in a text display.
